(19) United States
(12) Patent Application Publication
(10) Pub. No.: US 2021/0339371 A1
(43) Pub. Date: Nov. 4, 2021

(54) HYDRAULIC PERCUSSION APPARATUS EQUIPPED WITH A SEALING DEVICE

(71) Applicant: MONTABERT, Saint-Priest (FR)

(72) Inventor: Michel ESCOLLE, NIEVROZ (FR)

(21) Appl. No.: 17/294,240

(22) PCT Filed: Dec. 3, 2019
(86) PCT No.: PCT/FR2019/052903

§ 371 Date: May 14, 2021

(30) Foreign Application Priority Data
Dec. 14, 2018 (FR) 18/72902

(51) Int. Cl. B25D 9/12; F16J 15/16; F16J 15/3204

(52) U.S. Cl. CPC B25D 9/12; F16J 15/164; B25D 2250/345; B25D 2250/365; F16J 15/3204

(57) ABSTRACT

This hydraulic percussion apparatus, includes a guide body; a striking piston which is slidably mounted inside the guide body; a sealing device which is mounted in an annular retaining groove provided on the guide body so as to produce a sealing between a first fluid passage and a second fluid passage. The sealing device comprises includes an inner sealing ring including an inner sealing portion provided with a sealing lip sealingly cooperating with the striking piston, an annular protection portion which is internally delimited by a converging protection surface converging towards the sealing lip, an annular groove which is disposed between the sealing lip and the converging protection surface, and a balancing channel comprising first and second ends opening respectively into the annular groove and into an outer surface of the annular protection portion.

### CROSS REFERENCE TO RELATED APPLICATIONS

This application is a National Stage of PCT Application No. PCT/FR2019/052903 filed on Dec. 3, 2019, which claims priority to French Patent Application No. 18/72902 filed on Dec. 14, 2018, the contents each of which are incorporated herein by reference thereto.

### TECHNICAL FIELD

The present invention concerns a hydraulic percussion apparatus.

### BACKGROUND

The hydraulic percussion apparatuses, of the rock breaker or drill type, are generally equipped with a guide body comprising a bore, and a striking piston which is slidably mounted inside the bore and arranged to be alternately driven in translation by an incompressible fluid. In the particular case of a hydraulic rotary percussion apparatus, that is to say of the drill type, the striking piston can also possibly be driven in rotation about the longitudinal axis thereof.

In order to ensure a sealing between the guide body and the striking piston of a hydraulic percussion apparatus, and therefore to avoid an incompressible fluid loss, the guide body includes an annular retaining groove, coaxial with the striking piston and opening into the bore, in which a sealing device is mounted.

A first type of known sealing device consists of a one-piece seal having a U-shaped section and thus including a first inner sealing lip intended to cooperate with the outer surface of the striking piston in order to ensure a dynamic sealing between the seal and the moving striking piston, and an outer sealing lip intended to cooperate with the bottom of the annular retaining groove of the guide body in order to ensure a static sealing between the seal and the guide body.

Such a sealing device ensures a satisfactory sealing at low translation speed and low striking frequency of the striking piston.

However, during translational displacements of the striking piston, the contact between such a sealing device and the striking piston generates significant friction, and therefore a frictional heating of the striking piston which could lead to the destruction of the inner sealing lip.

In addition, in the case of a hydraulic rotary percussion apparatus, the rotation of the striking piston without translation of the latter does not allow ensuring proper lubrication and cooling of the inner sealing lip. This results in a rapid destruction of the inner sealing lip.

A second type of known sealing device consists of a sealing device comprising:
an inner sealing ring comprising:
   an inner sealing portion which is annular and which includes a sealing lip intended to sealingly cooperate with the outer surface of the striking piston,
   an annular protection portion which is offset axially relative to the inner sealing portion, the annular protection portion being internally delimited by at least one converging protection surface, the converging protection surface being annular and converging in the direction of the sealing lip,
   an annular groove opening towards the inside of the inner sealing ring, the annular groove being disposed between the sealing lip and the converging protection surface, and
an outer sealing element distinct from the inner sealing ring and mounted around the inner sealing ring, the outer sealing element being annular and intended to sealingly bear in the bottom of the annular retaining groove.

Such a sealing device ensures a satisfactory sealing at high translation speed and significant striking frequency of the striking piston, and low friction on the striking piston, therefore a low frictional heating of the sealing lip.

Furthermore, the configuration of the converging protection surface allows forming, with the outer surface of the striking piston, a progressive annular nozzle adapted to progressively reduce the thickness and the flow rate of the incompressible fluid flowing in the direction of the sealing lip, and therefore reducing the amplitude of the pressure peaks generated by very fast reciprocating movements of the incompressible fluid controlling the displacements of the striking piston.

In addition, the presence of the annular groove between the sealing lip and the converging protection surface allows reducing the incompressible fluid supply speed on the sealing lip by increasing the incompressible fluid passage surface, which allows further dampening residual pressure peaks.

Thus, the configuration of the inner sealing ring of the aforementioned second type of sealing device allows greatly reducing the amplitude of the previously mentioned pressure peaks, and therefore avoiding a breakage of the sealing lip. Therefore, the aforementioned second type of sealing device has an increased reliability.

However, a problem encountered with the aforementioned second type of sealing device lies in the fact that potential radial vibrations of the striking piston are likely to generate a pressure rise in the annular groove situated between the sealing lip and the converging protection surface.

The consequence of such a pressure rise in the annular groove is an undesirable enlargement of the inner diameter of the annular protection portion, thereby impairing the effectiveness of the annular protection portion, and consequently exposing the sealing lip to pressure peaks generated by the flow of the incompressible fluid. However, such exposure of the sealing lip to pressure peaks can lead to the destruction of the sealing lip.

In addition, if the radial movements of the striking piston manage to locally close the volume of the annular groove located between the annular protection portion and the sealing lip, the pressure rise of the annular groove can lead to the destruction of the inner sealing ring by overpressure.

### BRIEF SUMMARY

The present invention aims at overcoming all or part of these drawbacks.

The technical problem underlying the invention therefore consists in providing a hydraulic percussion apparatus comprising a sealing device which is simple in structure, economic, and reliable.

To this end, the present invention concerns a hydraulic percussion apparatus, comprising:
a guide body comprising a bore and an annular retaining groove formed on the guide body and opening into the bore,
a striking piston which is slidably mounted inside the bore in a direction of displacement and arranged to be alternately driven by an incompressible fluid,
a first fluid passage and a second fluid passage which are located on either side of the annular retaining groove and which are each defined between the guide body and the striking piston, the first fluid passage being located in the vicinity of a first lateral wall of the annular retaining groove and fluidly connecting the annular retaining groove to an incompressible fluid circuit associated to the reciprocating movement of the striking piston, the second fluid passage fluidly connecting the annular retaining groove to a compressible fluid circuit and being located in the vicinity of a second lateral wall of the annular retaining groove which is opposite to the first lateral wall, and
a sealing device which is mounted in the annular retaining groove so as to produce a sealing between the first fluid passage and the second fluid passage, the sealing device comprising:
an inner sealing ring comprising:
   an inner sealing portion which is annular and which includes a sealing lip intended to sealingly cooperate with the outer surface of the striking piston,
   an annular protection portion which is offset axially relative to the inner sealing portion, the annular protection portion being internally delimited by at least one converging protection surface, the converging protection surface being annular and converging in the direction of the sealing lip,
   an annular groove opening towards the inside of the inner sealing ring, the annular groove being disposed between the sealing lip and the converging protection surface, and
   at least one balancing channel comprising a first end opening into the annular groove and a second end opening into an outer surface of the annular protection portion, the at least one balancing channel being configured to fluidly connect the annular groove to the first fluid passage when the pressure in the first fluid passage is greater than the pressure in the second fluid passage, and
an outer sealing element distinct from the inner sealing ring and mounted around the inner sealing ring, the outer sealing element being annular and intended to sealingly bear in the bottom of the annular retaining groove.

The presence of the at least one balancing channel allows, when the reciprocating movement of the striking piston is activated and in the case of a violent radial movement of the striking piston, fluidly connecting the annular groove to the first fluid passage and therefore to the incompressible fluid circuit of the hydraulic percussion apparatus. The pressure in the annular groove then remains close to the pressure of the incompressible fluid circuit which is not subjected to the radial vibrations of the striking piston.

Consequently, the presence of the at least one balancing channel allows maintaining the effectiveness of the annular protection portion against the pressure peaks related to the very fast reciprocating movements of the incompressible fluid, and therefore maintaining the reliability of the sealing device, including in the case of a violent radial movement of the striking piston.

The hydraulic percussion apparatus may further have one or more of the following features, considered alone or in combination.

According to one embodiment of the invention, the at least one balancing channel is provided on the annular protection portion.

According to one embodiment of the invention, the second end of the at least one balancing channel is oriented towards the first lateral wall of the annular retaining groove.

According to one embodiment of the invention, the annular protection portion includes an annular balancing groove formed on an outer surface of the annular protection portion, the second end of the at least one balancing channel opening into the annular balancing groove. Advantageously, the annular balancing groove is substantially coaxial with the striking piston.

According to one embodiment of the invention, the second end of the at least one balancing channel opens into an end surface of the inner sealing ring facing the first lateral wall of the annular retaining groove.

According to one embodiment of the invention, the at least one balancing channel has a diameter comprised between 0.4 and 1.2 mm, and for example of about 0.7 mm.

According to one embodiment of the invention, each of the first and second fluid passages is annular.

According to one embodiment of the invention, the compressible fluid circuit is a pressurized lubricated air circuit configured to cool and lubricate mechanical members of the hydraulic percussion apparatus.

According to one embodiment of the invention, the hydraulic percussion apparatus is configured such that when the pressure in the second fluid passage is greater than the pressure in the first fluid passage, that is to say when the reciprocating movement of the striking piston is stopped, the sealing device is displaced in contact with the first lateral wall of the annular retaining groove and the second end of the at least one balancing channel is closed by the outer sealing element or by the first lateral wall.

When the pressure of the compressible fluid increases to a value greater than that of the incompressible fluid, mainly when the reciprocating movement of the striking piston is stopped, the inner sealing ring and outer sealing element are pushed by the pressure of the compressible fluid towards the first lateral wall of the annular retaining groove receiving the sealing device, and the second end of the at least one balancing channel is closed by the outer sealing element or by the first lateral wall. Furthermore, the outer sealing element exerts a radial force mainly on the annular protection portion, and the intersection of the annular groove with the annular protection portion then becomes a sealing edge, such that the annular groove located between the inner sealing portion and the annular protection portion is no longer in fluid communication with the incompressible fluid circuit. Consequently, the compressible and incompressible fluid circuits are again well separated.

According to one embodiment of the invention, the hydraulic percussion apparatus is configured such that, when the pressure in the first fluid passage is greater than the pressure in the second fluid passage, that is to say mainly when the reciprocating movement of the striking piston is activated, the sealing device is displaced in contact with the second lateral wall of the annular retaining groove and the second end of the at least one balancing channel is released so as to fluidly connect the annular groove to the first fluid passage via the at least one balancing channel. In particular, when the second end of the at least one balancing channel is released, the sealing device enables an incompressible fluid flow from the annular groove and through the at least one balancing channel and a discharge of said incompressible fluid through the second end of the at least one balancing channel.

When the reciprocating movement of the striking piston is activated (that is to say, when the percussion of the hydraulic apparatus is activated), the incompressible fluid is under a pressure greater than that of the compressible fluid. The inner sealing ring and the outer sealing element are therefore pushed by the incompressible fluid in contact with the second lateral wall of the annular retaining groove. In this normal working position, the second end of the at least one balancing channel is released and the sealing device effectively separates the incompressible fluid from the compressible fluid. Indeed, the sealing lip is protected, by the annular protection portion, from pressure peaks related to the very fast reciprocating movements of the incompressible fluid, and the sealing device, and in particular the annular protection portion, is protected from pressure peaks which are generated by the potential radial movement of the striking piston by the at least one balancing channel.

According to one embodiment of the invention, the outer sealing element is displaceable and/or deformable between a closure configuration in which the outer sealing element closes the second end of the at least one balancing channel, and a release configuration in which the outer sealing element releases the second end of the at least one balancing channel.

According to one embodiment of the invention, the annular protection portion is arranged to delimit an annular flow passage with the striking piston at least when the pressure in the first fluid passage is greater than the pressure in the second fluid passage.

According to one embodiment of the invention, the sealing lip protrudes radially inwardly relative to the annular protection portion.

Advantageously, the outer sealing element is arranged to exert a compressive force on the inner sealing portion at least when the pressure in the first fluid passage is greater than the pressure in the second fluid passage.

According to one embodiment of the invention, the outer sealing element is arranged to exert a compressive force on the annular protection portion at least when the pressure in the second fluid passage is greater than the pressure in the first fluid passage.

According to one embodiment of the invention, the annular groove is delimited by the sealing lip and the annular protection portion.

According to one embodiment of the invention, the converging protection surface extends from one end of the inner sealing ring facing the first lateral wall of the annular retaining groove.

According to one embodiment of the invention, the converging protection surface has an apex angle comprised between 10 and 40°. Therefore, the axial components of the hydraulic forces resulting from pressure peaks remain low on the converging protection surface.

According to one embodiment of the invention, the annular protection portion extends longitudinally over more than half the length of the inner sealing ring.

According to one embodiment of the invention, the converging protection surface extends longitudinally over at least 20% of the length of the inner sealing ring.

According to one embodiment of the invention, the annular protection portion is further internally delimited by a diverging protection surface which is annular and which diverges in the direction of the sealing lip, the diverging protection surface being disposed between the converging protection surface and the sealing lip, and delimiting at least partially the annular groove.

According to one embodiment of the invention, the first end of the at least one balancing channel opens into the diverging protection surface.

According to one embodiment of the invention, the diverging protection surface has an apex angle of less than 140°, and for example less than 90°.

According to one embodiment of the invention, the diverging protection surface has a radial height of at least 5/10th of a millimeter.

According to one embodiment of the invention, the converging protection surface and/or the diverging protection surface are substantially frustoconical.

According to one embodiment of the invention, the annular protection portion is further internally delimited by an intermediate protection surface which is substantially cylindrical and disposed between the converging protection surface and the annular groove. The presence of such an intermediate protection surface allows forming, with the outer surface of the striking piston, an annular nozzle adapted to greatly reduce the flow rate of the incompressible fluid from the converging protection surface, and therefore the associated pressure fluctuations. This results in a further improved protection of the sealing lip.

According to one embodiment of the invention, the intermediate protection surface is disposed between the converging protection surface and the diverging protection surface.

According to one embodiment of the invention, the intermediate protection surface extends in the extension of the converging protection surface.

According to one embodiment of the invention, the diverging protection surface extends in the extension of the intermediate protection surface. Such an arrangement of the diverging protection surface allows transforming the purely axial component of the speed of the incompressible fluid from the intermediate protection surface into an axial component and a radial component, and therefore further reducing the incompressible fluid supply speed on the sealing lip.

According to one embodiment of the invention, at least one of the converging, intermediate and diverging protection surfaces extends substantially coaxially with the longitudinal axis of the inner sealing ring. Advantageously, the converging, intermediate and diverging protection surfaces extend substantially coaxially with the longitudinal axis of the inner sealing ring.

According to one embodiment of the invention, the outer sealing element includes an annular bearing portion which is mounted around the inner sealing portion, and which sealingly bears in the bottom of the annular retaining groove.

According to one embodiment of the invention, the outer sealing element includes an annular holding portion which is mounted around the annular protection portion, and which sealingly bears in the bottom of the annular retaining groove. These arrangements allow maintaining the space between the striking piston and the different protection surfaces substantially constant regardless of the pressure of the incompressible fluid. This results in a protection against the peaks of fluid pressure which is almost independent of the average pressure level of the latter.

According to a first alternative of the invention, the annular holding portion is integral with the annular bearing portion. In other words, the annular holding portion and the annular bearing portion are made in one-piece part.

Advantageously, the annular holding portion is arranged to exert a compressive force on the annular protection portion at least when the pressure in the second fluid passage is greater than the pressure in the first fluid passage.

Preferably, the holding portion is axially offset from the annular bearing portion.

According to one embodiment of the invention, the annular bearing portion and the annular holding portion include respectively first and second inner bearing surfaces, and the inner sealing portion and the annular protection portion include respectively first and second outer bearing surfaces arranged to cooperate respectively with the first and second inner bearing surfaces. These arrangements allow increasing the friction exerted on the outer surface of the inner sealing ring, and thus limiting, during a possible rotation of the striking piston about the longitudinal axis thereof, the risks of relative rotation between the inner sealing ring and the outer sealing element. This results in a decrease in the risks of wear of the sealing device at the interface between the inner sealing ring and the outer sealing element, and therefore the risks of leakage between the guide body and the striking piston.

According to one embodiment of the invention, the annular balancing groove is formed on the second outer bearing surface of the annular protection portion.

According to one embodiment of the invention, the second outer bearing surface which is formed on the annular protection portion is substantially cylindrical and extends substantially parallel to the longitudinal axis of the inner sealing ring.

According to one embodiment of the invention, the second outer bearing surface which is formed on the annular protection portion is concave.

According to one embodiment of the invention, the first and second inner bearing surfaces are substantially cylindrical and extend substantially parallel to the longitudinal axis of the inner sealing ring.

According to one embodiment of the invention, the first and second outer bearing surfaces are substantially cylindrical and extend substantially parallel to the longitudinal axis of the inner sealing ring.

According to one embodiment of the invention, the first and second outer bearing surfaces extend in the extension of each other.

According to one embodiment of the invention, the inner sealing ring includes, at each of the ends thereof, an annular outer chamfer. The presence of such chamfers allows facilitating the mounting of the sealing device in the annular retaining groove formed on the guide body, and also avoiding a damage to the inner sealing ring on the edges of the annular retaining groove, that is to say the edges delimited by the lateral walls of the retaining groove and the inner wall of the guide body, which could impair the sealing between the sealing device and the striking piston.

According to one embodiment of the invention, each annular outer chamfer extends longitudinally and radially over at least 2/10th of a millimeter.

According to one embodiment of the invention, each annular outer chamfer has a chamfer angle comprised between 10 and 60° relative to a plane perpendicular to the longitudinal axis of the inner sealing ring.

According to one embodiment of the invention, the outer sealing element includes, at each of the ends thereof, an annular inner chamfer.

According to one embodiment of the invention, each annular inner chamfer has a chamfer angle comprised between 10 and 60° relative to a plane perpendicular to the longitudinal axis of the inner sealing ring.

According to one embodiment of the invention, the at least one balancing channel is inclined relative to the longitudinal axis of the inner sealing ring.

According to one embodiment of the invention, the at least one balancing channel extends substantially parallel relative to the longitudinal axis of the inner sealing ring.

According to one embodiment of the invention, the inner sealing ring comprises a plurality of balancing channels.

According to one embodiment of the invention, the sealing lip includes a sealing edge intended to sealingly cooperate with the outer surface of the striking piston.

According to one embodiment of the invention, the intermediate protection surface comprises an inner diameter comprised between a minimum value corresponding to the inner diameter of the sealing lip increased by 1/10th of a millimeter and a maximum value corresponding to the outer diameter of the striking piston increased by 1 millimeter.

According to one embodiment of the invention, the inner diameter of the inner sealing ring, at the end face of the annular protection portion facing the first lateral wall of the annular retaining groove, is greater than or equal to the diameter of the bore, at the end of the first fluid passage facing the inner sealing ring.

In other words, the radial height of the inner sealing ring, at the end face of the annular protection portion opposite to the inner sealing portion is greater than or equal to the radial height of the end of the first fluid passage facing the inner sealing ring.

According to one embodiment of the invention, the sealing device is configured to produce a sealing between the first fluid passage and the second fluid passage regardless of the operating conditions of the hydraulic percussion apparatus, and in particular both when the second end of the at least one balancing channel is closed and when the second end of the at least one balancing channel is released, that is to say both when the pressure in the second fluid passage is greater than the pressure in the first fluid passage and when the pressure in the first fluid passage is greater than the pressure in the second fluid passage.

According to one embodiment of the invention, the sealing device is configured to prevent the compressible fluid coming from the second fluid passage from entering the first fluid passage when the pressure in the second fluid passage is greater than the pressure in the first fluid passage. In particular, the sealing device is configured to prevent the compressible fluid coming from the second fluid passage to flow through the second end of the at least one balancing channel when the pressure in the second fluid passage is greater than the pressure in the first fluid passage.

According to one embodiment of the invention, the annular protection portion comprises at least one radial notch opening into the end face of the inner sealing ring facing the first lateral wall of the annular retaining groove.

According to one embodiment of the invention, the annular protection portion comprises at least one radial notch opening into the end face of the inner sealing ring facing the second lateral wall of the annular retaining groove.

According to one embodiment of the invention, the at least one balancing channel is open only at the first and second ends thereof. In other words, the at least one balancing channel is integrally formed in the material of the inner sealing ring.

According to one embodiment of the invention, the at least one balancing channel is generally tubular.

According to one embodiment of the invention, the hydraulic percussion apparatus is configured such that:
when the pressure in the second fluid passage is greater than the pressure in the first fluid passage, the sealing device is displaced in contact with the first lateral wall of the annular retaining groove and the outer sealing element is displaced and/or deformed into the closure configuration in which the outer sealing element closes the second end of the at least one balancing channel;
when the pressure in the first fluid passage is greater than the pressure in the second fluid passage, the sealing device is displaced in contact with the second lateral wall of the annular retaining groove and the outer sealing element is displaced and/or deformed into the release configuration in which the outer sealing element releases the second end of the at least one balancing channel so as to fluidly connect the annular groove to the first fluid passage via the at least one balancing channel.

According to one embodiment of the invention, the outer sealing element is axially displaceable between the closure configuration and the release configuration.

According to one embodiment of the invention, the second end of the at least one balancing channel opens into an outer circumferential surface of the annular protection portion.

In any case, the invention will be well understood using the following description with reference to the appended schematic drawings representing, by way of non-limiting examples, two embodiments of this hydraulic percussion apparatus.

### BRIEF DESCRIPTION OF THE DRAWINGS

FIG. 1 is a partial sectional view of a hydraulic percussion apparatus according to a first embodiment of the invention and which is equipped with a sealing device shown in a percussion configuration.

FIG. 2 is a partial sectional view of the hydraulic percussion apparatus of FIG. 1 showing the sealing device in a percussion stop configuration.

FIG. 3 is a sectional view of a sealing device according to a second embodiment of the invention and which is shown in a percussion configuration.

FIG. 4 is a sectional view of the sealing device of FIG. 3 in a percussion stop configuration.

FIG. 5 is a sectional view of a sealing device according to a third embodiment of the invention and which is shown in a percussion configuration.

### DETAILED DESCRIPTION

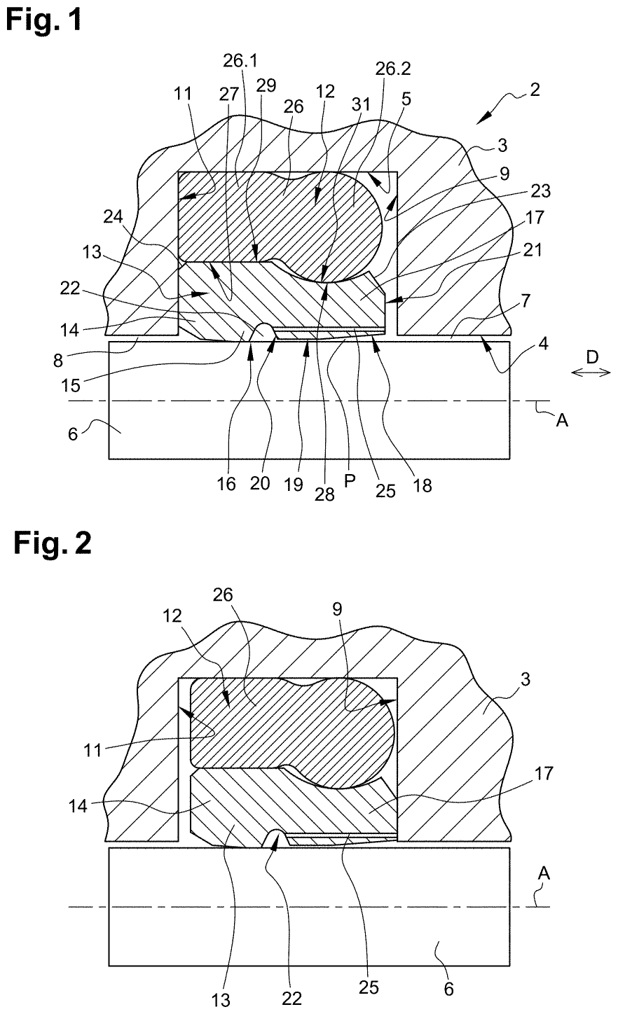

FIGS. 1 and 2 represent a hydraulic percussion apparatus 2 equipped with a guide body 3 comprising a bore 4 and an annular retaining groove 5 opening into the bore 4, and a cylindrically shaped striking piston 6 which is slidably mounted inside the bore 4 in a direction of displacement D and arranged to be alternately driven in translation by an incompressible fluid, such as hydraulic oil.

The hydraulic percussion apparatus 2 further comprises a first fluid passage 7 and a second fluid passage 8 which are annular and coaxial, and which are located on either side of the annular retaining groove 5. Each of the first and second fluid passages 7, 8 is delimited between the guide body 3 and the striking piston 6.

The first fluid passage 7 is located in the vicinity of a first lateral wall 9 of the annular retaining groove 5 and fluidly connects the annular retaining groove 5 to an incompressible fluid circuit associated to the reciprocating movement of the striking piston 6, while the second fluid passage 8 fluidly connects the annular retaining groove 5 to a compressible fluid circuit and is located in the vicinity of a second lateral wall 11 of the annular retaining groove 5 which is opposite to the first lateral wall 9. The compressible fluid circuit can for example be a pressurized lubricated air circuit configured to cool and/or lubricate mechanical members of the hydraulic percussion apparatus 2.

The hydraulic percussion apparatus 2 further comprises a sealing device 12 mounted in the annular retaining groove 5 so as to produce a sealing between the first fluid passage 7 and the second fluid passage 8, and more particularly so as to prevent an incompressible fluid passage from the first fluid passage 7 to the second fluid passage 8, and so as to prevent a compressible fluid passage from the second fluid passage 8 to the first fluid passage 7.

The sealing device 12 comprises an inner sealing ring 13. The inner sealing ring 13 can be made of hard plastic, for example based on PTFE, PEEK, PU. The inner sealing ring 13 comprises an annular inner sealing portion 14 which is provided with an annular sealing lip 15 intended to sealingly cooperate with the outer surface of the striking piston 6. Advantageously, the sealing lip 15 includes a sealing edge 16 intended to sealingly cooperate with the outer surface of the striking piston 6.

The inner sealing ring 13 further comprises an annular protection portion 17 which is axially offset from the inner sealing portion 14. The inner sealing ring 13 is shaped such that the sealing lip 15 is substantially at the same level or protrudes radially inwardly relative to the annular protection portion 17. Thus, the annular protection portion 17 is arranged to delimit an annular flow passage P with the striking piston 6 when the reciprocating movement of the striking piston 6 is activated.

The annular protection portion 17 is internally delimited by a converging protection surface 18, an intermediate protection surface 19 and a diverging protection surface 20 which extend substantially coaxially with the longitudinal axis A of the inner sealing ring 13.

The converging protection surface 18 extends from one end of the inner sealing ring 13, and more particularly from one end face 21 of the annular protection portion 17 which is opposite to the inner sealing portion 14. The converging protection surface 18 is advantageously frustoconical and converges in the direction of the sealing lip 15. The converging protection surface 18 has for example an apex angle comprised between 2 and 40°. The converging protection surface 18 can for example further extend longitudinally over at least 20% of the length of the inner sealing ring 13.

The intermediate protection surface 19 extends in the extension of the converging protection surface 18 in the direction of the sealing lip 15. The intermediate protection surface 19 is substantially cylindrical, and preferably has an inner diameter comprised between a minimum value corresponding to the inner diameter of the sealing lip 15 increased by 1/10th of a millimeter and a maximum value corresponding to the outer diameter of the striking piston 6 increased by 1 millimeter.

The diverging protection surface 20 extends in the extension of the intermediate protection surface 19. The diverging protection surface 20 is frustoconical and diverges in the direction of the sealing lip 15. According to one embodiment of the invention, the diverging protection surface 20 has a radial height of at least 5/10th of a millimeter. According to one embodiment of the invention, the diverging protection surface 20 has an apex angle of less than 140°.

The inner sealing ring 13 also comprises an annular groove 22 facing the striking piston 6, the annular groove 22 being delimited by the sealing lip 15 and the diverging protection surface 20. The annular groove 22 is advantageously substantially coaxial with the striking piston 6.

The inner sealing ring 13 includes, at each of the ends thereof, an annular outer chamfer 23, 24. Each annular outer chamfer 23, 24 can for example extend longitudinally and radially over at least 2/10th of a millimeter. According to one embodiment of the invention, each annular outer chamfer 23, 24 has a chamfer angle comprised between 10 and 60° relative to a plane perpendicular to the longitudinal axis A of the inner sealing ring 13.

The inner diameter of the inner sealing ring 13, at the end face 21 of the annular protection portion 17 which is opposite to the inner sealing portion 14, is greater than or equal to the diameter of the bore 5, at the end of the first fluid passage 7 facing the inner sealing ring 13. In other words, the radial height of the inner sealing ring 13, at the end face 21 of the annular protection portion 17, is greater than or equal to the radial height of the end of the first fluid passage 7 facing the inner sealing ring 13. These arrangements allow preventing the incompressible fluid coming from the first fluid passage 7 from frontally striking the end face 21 of the annular protection portion 17, which would quickly damage the inner sealing ring 13.

The inner sealing ring 13 also includes one balancing channel 25 or several balancing channels 25 provided on the annular protection portion 17. The or each balancing channel 25 comprises a first end opening into the annular groove 22, and more particularly into the diverging protection surface 20, and a second end opening into an outer surface of the annular protection portion 17. Advantageously, the second end of the or each balancing channel 25 is oriented towards the first lateral wall 9 of the annular retaining groove 5.

According to the embodiment represented in FIGS. 1 and 2, the or each balancing channel 25 extends substantially parallel relative to the longitudinal axis A of the inner sealing ring 13, and the second end of the or each balancing channel 25 opens into the end face 21 of the annular protection portion 17.

The sealing device 2 further comprises an outer sealing element 26 distinct from the inner sealing ring 13 and mounted around the inner sealing ring 13. The outer sealing element 26 is annular and sealingly bears in the bottom of the annular retaining groove 5. The outer sealing element 26 may for example be made of elastomer.

According to the embodiment represented in FIGS. 1 and 2, the outer sealing element 26 includes an annular bearing portion 26.1 which is mounted around the inner sealing portion 14 and which sealingly bears in the bottom of the annular retaining groove 5, and an annular retaining portion 26.2 which is mounted around the annular protection portion 17 and which also sealingly bears in the bottom of the annular retaining groove 5. The annular holding portion 26.2 is thus offset axially relative to the annular bearing portion 26.1.

Advantageously, the annular bearing portion 26.1 is arranged to exert a compressive force on the inner sealing portion 14 at least when the pressure in the first fluid passage 7 is greater than the pressure in the second fluid passage. 8, and the annular holding portion 26.2 is arranged to exert a compressive force on the annular protection portion 17 at least when the pressure in the second fluid passage 8 is greater than the pressure in the first fluid passage 7.

The annular bearing portion 26.1 and the annular holding portion 26.2 include respectively first and second inner bearing surfaces 27, 28, and the inner sealing portion 14 and the annular protection portion 17 include respectively first and second outer bearing surfaces 29, 31 which are arranged to cooperate respectively with the first and second inner bearing surfaces 27, 28. According to the embodiment represented in FIGS. 1 and 2, the first outer bearing surface 29 formed on the inner sealing portion 14 is substantially cylindrical and extends substantially parallel to the longitudinal axis A of the inner sealing ring 13, while the second outer bearing surface 31 formed on the annular protection portion 17 is concave.

The hydraulic percussion apparatus 2 is more particularly configured such that, when the pressure in the first fluid passage 7 is greater than the pressure in the second fluid passage 8, that is to say when the reciprocating movement of the striking piston 6 is activated, the inner sealing ring 13 and the outer sealing element 26 are displaced by the pressure of the incompressible fluid in contact with the second lateral wall 11 of the annular retaining groove 5 and the second end of the or each balancing channel 25 is released so as to fluidly connect the annular groove 22 to the first fluid passage 7 via the or each balancing channel 25. In particular, when the second end of the or each balancing channel 25 is released, the sealing device 12 enables an incompressible fluid flow from the annular groove 22 and through the or each balancing channel 25 and a discharge of said incompressible fluid through the second end of the or each balancing channel 25. The pressure in the annular groove 22 then remains close to the pressure of the incompressible fluid circuit which is not directly subjected to the radial vibrations of the striking piston 6.

Thus, when the reciprocating movement of the striking piston 6 is activated, the sealing lip 15 is protected, by the annular protection portion 17, from the pressure peaks related to the very fast reciprocating movements of the incompressible fluid, and the annular protection portion 17 is protected from the pressure peaks generated by the potential radial movement of the striking piston 6 by the or each balancing channel 25.

Consequently, the presence of the or each balancing channel 25 allows maintaining the effectiveness of the annular protection portion 17 against the pressure peaks related to the very fast reciprocating movements of the incompressible fluid, and therefore maintaining the reliability of the sealing device 12, including in the case of a violent radial movement of the striking piston 6.

The hydraulic percussion apparatus 2 is further configured such that, when the pressure in the second fluid passage 8 is greater than the pressure in the first fluid passage 7, that is to say mainly when the reciprocating movement of the striking piston 6 is stopped, the inner sealing ring 13 and the outer sealing element 26 are displaced by the pressure of the compressible fluid in contact with the first lateral wall 9 of the annular retaining groove 5 and the second end of the or each balancing channel 25 is closed by the first lateral wall 9.

Furthermore, due to the fact that the annular holding portion 26.2 exerts a compressive force on the annular protection portion 17 when the pressure in the second fluid passage 8 is greater than the pressure in the first fluid passage 7, the intersection of the annular groove 22 with the intermediate protection surface 19 then becomes a sealing edge, such that the annular groove 22 is fluidly isolated from the incompressible fluid circuit, which ensures a separation of the compressible and incompressible fluid circuits even in case of lifting the sealing lip 15.

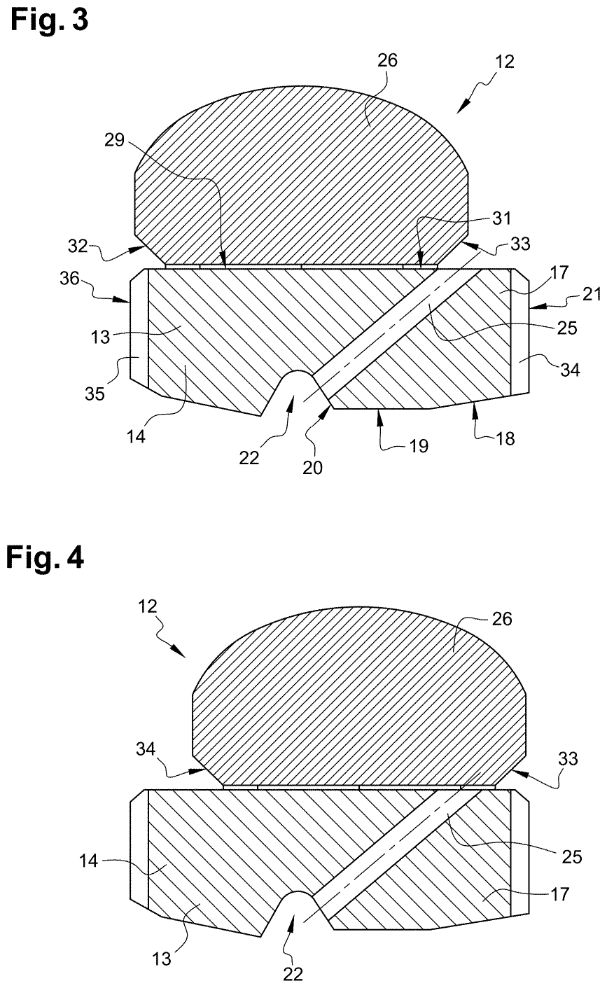

FIGS. 3 and 4 represent a sealing device 12 according to a second embodiment of the invention which differs from the first embodiment represented in FIGS. 1 and 2 essentially in that the or each balancing channel 25 is inclined relative to the longitudinal axis A of the inner sealing ring 13, and in that the outer sealing element 26 is axially displaceable between a closure configuration in which the outer sealing element 26 closes the second end of the or each balancing channel 25, and a release configuration in which the outer sealing element 26 releases the second end of the or each balancing channel 25.

According to the second embodiment of the invention, the second end of the or each balancing channel 25 opens into an outer circumferential surface of the annular protection portion 17, and more particularly into the second outer bearing surface 31 of the annular protection portion 17.

Furthermore, according to the second embodiment of the invention, the first and second outer bearing surfaces 29, 31 are substantially cylindrical and extend substantially parallel to the longitudinal axis A of the inner sealing ring 13 and in the extension of each other.

As shown in FIGS. 3 and 4, the outer sealing element 26 may further include, at each of the ends thereof, an annular inner chamfer 32, 33. Each annular inner chamfer 32, 33 may for example extend longitudinally and radially over at least 2/10th of a millimeter. According to one embodiment of the invention, each annular inner chamfer 32, 33 has a chamfer angle comprised between 10 and 60° relative to a plane perpendicular to the longitudinal axis A of the inner sealing ring 13.

In addition, the annular protection portion 17 can also comprise at least one radial notch 34 opening into the end face 21 of the inner sealing ring 13 and at least one radial notch 35 opening into the end face 36 of the inner sealing ring 13 facing the second lateral wall 11 of the annular retaining groove 5.

In normal operation of the hydraulic percussion apparatus 2, when the pressure in the first fluid passage 7 is greater than the pressure in the second fluid passage 8, the inner sealing ring 13 and the outer sealing element 26 are displaced by the pressure of the incompressible fluid in contact with the second lateral wall 11 of the annular retaining groove 5 and the outer sealing element 26 releases the second end of the or each balancing channel 25 so as to fluidly connect the annular groove 22 to the first fluid passage 7 via the or each balancing channel 25.

Thus, the axial pressure fluctuations, generated by the very fast reciprocating movements of the incompressible fluid flowing in the first fluid passage 7, are attenuated by the converging protection surface 18, the intermediate protection surface 19 and the diverging protection surface 20.

Furthermore, possible overpressures generated in the annular groove 22 by radial movements of the striking piston 6 are discharged via the or each balancing channel 25, such that the pressure in the annular groove 22 then remains close to the pressure of the incompressible fluid circuit.

Taking into account the particular configuration of the or each balancing channel 25, the axial pressure fluctuations from the first fluid passage 7 do not flow directly into the or each balancing channel 25, but previously flow along the end face 21 of the annular protection portion 17 and the second outer bearing surface 31 and are therefore attenuated by the end face 21 and the second outer bearing surface 31. These axial pressure fluctuations are also attenuated due to the inclined configuration of the or each balancing channel 25.

Consequently, the presence of the or each balancing channel 25, which ensures a protection against the radial vibrations to the hydraulic percussion apparatus 2, does not interfere with the protection against the axial vibrations ensured by the converging protection surface 18, the intermediate protection surface 19 and the diverging protection surface 20.

When the hydraulic percussion apparatus 2 is at rest, the pressure in the second fluid passage 8 is greater than the pressure in the first fluid passage 7, the inner sealing ring 13 and the outer sealing element 26 are then displaced by the pressure of the compressible fluid in contact with the first lateral wall 9 of the annular retaining groove 5 and the second end of the or each balancing channel 25 is closed by the outer sealing element 26.

The compressible fluid from the second fluid passage 8 can, by leakage of the sealing lip 15, flow into the annular groove 22. The intermediate protection surface 19 then seals the striking piston 6, because the outer sealing element 26 presses on the second outer bearing surface 31 of the annular protection portion 17 and rotates it towards the striking piston 6. The second end of the or each balancing channel 25 being closed by the outer sealing element 26, the risk of leakage of the compressible fluid in the first fluid passage 7 is thus substantially reduced. In addition, although the material of the inner sealing ring 13 can be very hard, the seal at the second end of the or each balancing channel 25 is guaranteed because the outer sealing member 26 is generally made of a softer material than the material of the inner sealing ring 13.

Thus, the risks of fluid leakage via the second end of the or each balancing channel 25 when the hydraulic percussion apparatus 2 is at rest are relatively low or even zero.

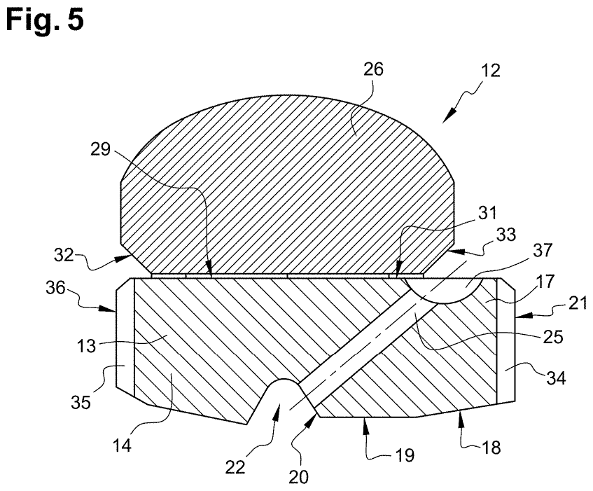

FIG. 5 represents a sealing device 12 according to a third embodiment of the invention which differs from the second embodiment represented in FIGS. 3 and 4 essentially in that the annular protection portion 17 includes an annular balancing groove 37 formed on an outer surface of the annular protection portion 17, and in that the second 15 end of the or each balancing channel 25 opens into the annular balancing groove 37. Advantageously, the annular balancing groove 37 is substantially coaxial with the striking piston 6, and is formed on the second outer bearing surface 31 of the annular protection portion 17.

The presence of such an annular balancing groove 37 facilitates the machining of the or each balancing channel 25 as well as the discharge of the incompressible fluid in the direction of the first fluid passage 7 when the reciprocating movement of the striking piston 6 is activated and in the case of violent radial movement of the striking piston 6.

It goes without saying that the invention is not only limited to the sole embodiments of this hydraulic percussion apparatus, described hereinabove by way of examples, it encompasses on the contrary all variants thereof.

1. A hydraulic percussion apparatus, comprising:
a guide body comprising a bore and an annular retaining groove formed on the guide body and opening into the bore,
a striking piston which is slidably mounted inside the bore in a direction of displacement and arranged to be alternately driven by an incompressible fluid,
a first fluid passage and a second fluid passage which are located on either side of the annular retaining groove and which are each defined between the guide body and the striking piston, the first fluid passage being located in the vicinity of a first lateral wall of the annular retaining groove and fluidly connecting the annular retaining groove to an incompressible fluid circuit associated to the reciprocating movement of the striking piston, the second fluid passage fluidly connecting the annular retaining groove to a compressible fluid circuit and being located in the vicinity of a second lateral wall of the annular retaining groove which is opposite to the first lateral wall, and
a sealing device which is mounted in the annular retaining groove so as to produce a sealing between the first fluid passage and the second fluid passage, the sealing device comprising:
an inner sealing ring comprising:
an inner sealing portion which is annular and which includes a sealing lip intended to sealingly cooperate with the outer surface of the striking piston,
an annular protection portion which is offset axially relative to the inner sealing portion, the annular protection portion being internally delimited by at least one converging protection surface, the converging protection surface being annular and converging in the direction of the sealing lip,
an annular groove opening towards the inside of the inner sealing ring, the annular groove being disposed between the sealing lip and the converging protection surface, and
at least one balancing channel comprising a first end opening into the annular groove and a second end opening into an outer surface of the annular protection portion, the at least one balancing channel being configured to fluidly connect the annular groove to the first fluid passage when the pressure in the first fluid passage is greater than the pressure in the second fluid passage, and
an outer sealing element distinct from the inner sealing ring and mounted around the inner sealing ring, the outer sealing element being annular and intended to sealingly bear in the bottom of the annular retaining groove.

2. The hydraulic percussion apparatus according to claim 1, wherein the second end of the at least one balancing channel is oriented towards the first lateral wall of the annular retaining groove.

3. The hydraulic percussion apparatus according to claim 1, which is configured such that when the pressure in the second fluid passage is greater than the pressure in the first fluid passage, the sealing device is displaced in contact with the first lateral wall of the annular retaining groove and the second end of the at least one balancing channel is closed by the outer sealing element or by the first lateral wall.

4. The hydraulic percussion apparatus according to claim 1, which is configured such that when the pressure in the first fluid passage is greater than the pressure in the second fluid passage, the sealing device is displaced in contact with the second lateral wall of the annular retaining groove and the second end of the at least one balancing channel is released so as to fluidly connect the annular groove to the first fluid passage via the at least one balancing channel.

5. The hydraulic percussion apparatus according to claim 3, wherein the sealing device is configured to produce a sealing between the first fluid passage and the second fluid passage both when the second end of the at least one balancing channel is closed and when the second end of the at least one balancing channel is released.

6. The hydraulic percussion apparatus according to claim 1, wherein the outer sealing element is displaceable and/or deformable between a closure configuration in which the outer sealing element closes the second end of the at least one balancing channel, and a release configuration in which the outer sealing element releases the second end of the at least one balancing channel.

7. The hydraulic percussion apparatus percussion apparatus according to claim 1, wherein the annular protection portion is arranged to delimit an annular flow passage with the striking piston.

8. The hydraulic percussion apparatus according to claim 1, wherein the converging protection surface extends from one end of the inner sealing ring facing the first lateral wall of the annular retaining groove.

9. The hydraulic percussion apparatus according to claim 1, wherein the annular protection portion is further internally delimited by a diverging protection surface which is annular and which diverges in the direction of the sealing lip, the diverging protection surface being disposed between the converging protection surface and the sealing lip, and delimiting at least partially the annular groove.

10. The hydraulic percussion apparatus according to claim 9, wherein the first end of the at least one balancing channel opens into the diverging protection surface.

11. The hydraulic percussion apparatus according to claim 1, wherein the annular protection portion is further internally delimited by an intermediate protection surface which is substantially cylindrical and disposed between the converging protection surface and the annular groove.

12. The hydraulic percussion apparatus according to claim 9, wherein the intermediate protection surface is disposed between the converging protection surface and the diverging protection surface.

13. The hydraulic percussion apparatus according to claim 1, wherein the inner sealing ring includes, at each of the ends thereof, an annular outer chamfer.

14. The hydraulic percussion apparatus according to claim 1, wherein the outer sealing element includes, at each of the ends thereof, an annular inner chamfer.

15. The hydraulic percussion apparatus according to claim 1, wherein the at least one balancing channel is open only at the first and second ends thereof.

16. The hydraulic percussion apparatus according to claim 2, which is configured such that when the pressure in the second fluid passage is greater than the pressure in the first fluid passage, the sealing device is displaced in contact with the first lateral wall of the annular retaining groove and the second end of the at least one balancing channel is closed by the outer sealing element or by the first lateral wall.

17. The hydraulic percussion apparatus according to claim 16, which is configured such that when the pressure in the first fluid passage is greater than the pressure in the second fluid passage, the sealing device is displaced in contact with the second lateral wall of the annular retaining groove and the second end of the at least one balancing channel is released so as to fluidly connect the annular groove to the first fluid passage via the at least one balancing channel.

18. The hydraulic percussion apparatus according to claim 17, wherein the sealing device is configured to produce a sealing between the first fluid passage and the second fluid passage both when the second end of the at least one balancing channel is closed and when the second end of the at least one balancing channel is released.

19. The hydraulic percussion apparatus according to claim 18, wherein the outer sealing element is displaceable and/or deformable between a closure configuration in which the outer sealing element closes the second end of the at least one balancing channel, and a release configuration in which the outer sealing element releases the second end of the at least one balancing channel.

20. The hydraulic percussion apparatus percussion apparatus according to claim 19, wherein the annular protection portion is arranged to delimit an annular flow passage with the striking piston.
